(19) United States
(12) Patent Application Publication
(10) Pub. No.: US 2026/0109824 A1
(43) Pub. Date: Apr. 23, 2026

(54) RECYCLABLE HIGH BARRIER PACKAGING FILMS

(71) Applicant: Retail Product Partner, San Gabriel, CA (US)

(72) Inventors: Tony Toan Nguyen, San Gabriel, CA (US); Jinlong Shi, Dongguan (CN)

(21) Appl. No.: 18/939,044

(22) Filed: Nov. 6, 2024

(30) Foreign Application Priority Data
Oct. 23, 2024 (WO) PCT/CN2024/126755

(51) Int. Cl. C08J 5/18; B32B 27/08; B32B 27/30; B32B 27/32

(52) U.S. Cl. CPC C08J 5/18; B32B 27/08; B32B 27/306; B32B 27/327; B32B 2250/03; B32B 2250/246; B32B 2255/10; B32B 2255/20; B32B 2305/70; B32B 2307/412; B32B 2307/518; B32B 2307/72; B32B 2307/7244; B32B 2307/7246; B32B 2307/736; B32B 2323/043; B32B 2329/04; B32B 2439/70; B32B 2439/80; C08J 2323/06; C08J 2323/08; C08J 2329/04

(57) ABSTRACT

Embodiments of the present application are related to high-barrier recyclable films for packaging having a composition of at least 90% high-density polyethylene. The films include an outer base film, an inner sealing film, and a barrier material between the outer base film and the inner sealing film. The films can be used for high-performance packaging applications and can by fully recyclable under SPI Code 2.

### INCORPORATION BY REFERENCE TO ANY PRIORITY APPLICATION

This application claims the benefit of priority to International Application No. PCT/CN2024/126755, filed Oct. 23, 2024, which is incorporated by reference in its entirety.

### BACKGROUND

### Field

The field relates generally to packaging such as films and bags suitable for packing for products that require high barrier such as for food, beverages or pharmaceuticals. The disclosure relates to high barrier films packaging films that are considered recyclable and have improved oxygen transmission properties. Packages made from the high barrier films are also provided.

### Description of the Related Art

Packaging materials that are recyclable are desired by both consumers and providers of goods for food, beverages and pharmaceuticals. In some cases, packaging materials that are recyclable satisfy certain compliance standards. High barrier packaging materials for food, beverages and pharmaceuticals typically are made from oriented polyethylene terephthalate (OPET) or biaxially oriented nylon (BON) in their outer layers. Such materials provide desirable characteristics such as high stiffness, printing quality and heat resistance. Without certain additional chemicals additives, however, both OPET and BON are not recyclable in current recycling streams.

Other materials commonly used for high-barrier packaging include polyvinylidene chloride (PVDC) and ethylene vinyl alcohol copolymer (EVOH). These materials are also challenging to recycle without the addition of certain chemical additives and are generally not accepted in recycling processes.

It is understood that a polyethylene structure can provide films that are recyclable. Polyethylene structures typically have low stiffness, limited heat resistance and provide moderate to low barrier. Packaging made from polyethylene structures tend not to meet the qualities desired for high barrier packaging. Poor heat resistance and low durability can lead to shrinking and scuffing of the packaging material, which can result in a poor appearance. Such qualities can also lead to poor heat seals causing non-hermetic packaging. Some methods for improving the performance of polyethylene-based films include a process of orienting the components, but such products continue to exhibit drawbacks with respect to heat resistance and stiffness.

Thus, there is a continuing need for films that are recyclable while also providing excellent mechanical properties, high barrier and heat resistance to meet the demands of high-performance packaging.

### SUMMARY

Some embodiments of the present disclosure relate to a packaging film, including: an outer base film; an inner scaling film; and a barrier material, wherein the barrier material is between the outer base film and the inner scaling film. In some embodiments, the outer base film can include high-density polyethylene (HDPE), and the inner sealing film can include HDPE and metallocene polyethylene (mPE). In some embodiments, the packaging film includes at least 90% HDPE by weight, the packaging film has an oxygen transmission rate of less than 1 cm³/m² per 24 hours, and the packaging film is fully recyclable under SPI Code 2.

In some embodiments, the packaging film can include at least 95% HDPE by weight. In some embodiments, the oxygen transmission rate of the packaging film can be less than 0.66 cm³/m² per 24 hours, or from about 0.01 cm³/m² per 24 hours to 1 cm³/m² per 24 hours, or at least 0.17 cm³/m² per 24 hours. In some embodiments, the packaging film can have a water vapor transmission rate from about 0.1 g/m² per 24 hours to about 3.0 g/m² per 24 hours, or from about 1.0 g/m² per 24 hours to about 3.0 g/m² per 24 hours. In some embodiments, the thickness of the packaging film can be from about 15 μm to about 200 μm. In some embodiments, the density of the packaging film can be from about 0.94 g/cm³ to about 1 g/cm³, or from about 0.95 g/cm³ to about 0.97 g/cm³. In some embodiments, the packaging film does not include polyvinyl chloride, low-density polyethylene, polypropylene, polystyrene, or polylactic acid.

In some embodiments, the outer base film of the packaging film can be a linear HDPE film, a high-density machine-direction orientation polyethylene (HD-MDOPE) film, a high-density biaxially oriented polyethylene (HD-BOPE) film, a high-density cast polyethylene (HD-CPE) film, an alumina coated HDPE film, an alumina coated HD-MDOPE film, an alumina coated HD-BOPE film, and an alumina coated HD-CPE film, and combinations thereof. In some embodiments, the outer base film can be formed by a blown film or co-extrusion process with 1, 2, 3, 5, 7, 9 or 11 layers. In some embodiments, one or more individual layers in the outer base film can be bonded together with an adhesive. In some embodiments, the outer base film can have a thickness from about 15 μm to about 200 μm. In some embodiments, the outer base film can have a density from about 0.94 g/cm³ to about 1 g/cm³, or from about 0.95 g/cm³ to about 0.97 g/cm³. In some embodiments, the outer base film can have a water vapor transmission rate from about 0.1 g/m² per 24 hours to about 3.0 g/m² per 24 hours. In some embodiments where the outer base film includes HD-MDOPE or HD-BOPE, the outer base film can have a free shrinkage rate of less than 7% in the longitudinal/machine direction and less than 7% in the transverse direction when heated to about 90° C.

In some embodiments, the barrier material can include a polyvinyl alcohol (PVA) or ethylene vinyl alcohol (EVOH), or a combination thereof. In some embodiments, the barrier material can have a thickness from about 0.5 μm to about 20 μm.

In some embodiments, the inner sealing film can include mPE and a HDPE selected from the group consisting of a linear HDPE film, a HD-MDOPE film, a HD-BOPE film, a HD-CPE film, an alumina coated HDPE film, an alumina coated HD-MDOPE film, an alumina coated HD-BOPE film, and an alumina coated HD-CPE film, and combinations thereof. In some embodiments, the inner sealing film can be formed by a blown film process with 1, 2, 3, 5, 7, 9 or 11 layers.

In some embodiments, the outer base film and the barrier material can be bonded together by a coating process. In some embodiments, the inner sealing film and the barrier material can be bonded together by a coating process.

Some embodiments of the present disclosure relate to a product package made from the packaging film described herein. In some embodiments, the product package can be a pouch, a bag, or a bag-in-box liner.

Some embodiments of the present disclosure relate to a method of manufacturing the packaging film described herein, including extruding one or more high-density polyethylene film layers to form the outer base film; orienting the outer base film in the machine direction; annealing the outer base film; coating the barrier material onto the outer base film or the inner sealing film; and connecting the outer base film to the inner sealing film to form the packaging film, wherein the barrier material is between the outer base film and the inner sealing film. In some embodiments, the method can further include heat sealing the packaging film to form a product package. In some embodiments, the method can further include irradiating the outer base film to form crosslinks in at least an outer surface of the outer base film.

### BRIEF DESCRIPTION OF THE DRAWINGS

FIG. 1 shows a schematic diagram of an embodiment of a packaging film as described herein.

FIG. 2 shows a schematic diagram of an embodiment of a package made from a packaging film according to an embodiment of the present disclosure.

FIGS. 3A-3E show schematic diagram of various embodiments of a packaging film as described herein.

FIG. 4 shows two packages made from a packaging film according to an embodiment described herein.

### DETAILED DESCRIPTION

Films and packaging of the current disclosure are recyclable and provide high barrier to protect the products contained therein. The properties of the high-barrier recyclable films mimic many of the important properties of related non-recyclable high-performance packaging films, including heat resistance, good appearance, high transparency, heat stability (low shrink), and low transmission of oxygen, moisture and other migratory species (high barrier). The structures provided have high levels of polyethylene materials and include low levels of barrier materials and other non-polyethylene materials. The improved combination of materials and processing described herein provide films with a unique combination of recyclability and performance.

The packaging film includes an outer base film, an inner sealing film, and a barrier material, wherein the barrier material is between the outer base film and the inner sealing film. The outer base film includes high-density polyethylene (HDPE). The inner sealing film includes HDPE and metallocene polyethylene (mPE).

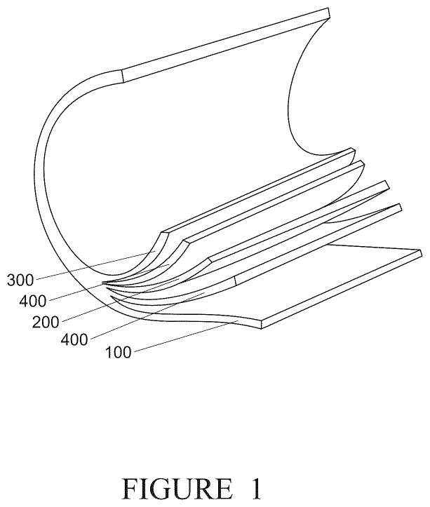

FIG. 1 is a side cross-section view schematic of an example packaging film. The packaging film includes an outer base film 100 made of HDPE, a barrier material 200 made of EVOH, an inner sealing film 300 made of HDPE, and adhesive layers 400 between the outer base film and the barrier material and between the barrier material and the inner sealing film. In a non-limiting embodiment, inner sealing film 300 can be made of HDPE and mPE. In other non-limiting embodiments, the HDPE of the outer base film 100 or the inner sealing layer 300 can be formed by a multilayer co-extrusion blown film process, with 1, 2, 3, 5, 7, 9 or 11 layers. In some non-limiting embodiments, the adhesive layer 400 can be glue or a tie material.

Polyethylene is the name for a polymer whose basic structure is characterized by the chain —(CH₂—CH₂—)ₙ. As used herein, the term “polyethylene” includes homopolymers and copolymers of ethylene. There are several broad categories of polymers referred to as “polyethylene.” Placement of a particular polymer into one of these categories of polyethylene is frequently based upon the density of the polyethylene and often by additional reference to the process by which it was made since the process often determines the degree of branching, crystallinity and density. In general, the nomenclature used is nonspecific to a compound but refers instead to a range of compositions. This range often includes both homopolymers and copolymers.

High density polyethylene” (HDPE) refers to polyethylene with densities from about 0.94 g/cm³ to about 0.97 g/cm³. Some examples of HDPE include, but are not limited to, linear HDPE, high-density machine-direction orientation polyethylene (HD-MDOPE), high-density biaxially oriented polyethylene (HD-BOPE), high density cast polyethylene (HD-CPE), and combinations thereof. In some embodiments, HDPE can be alumina coated. HDPE is recognized as a recyclable material in the U.S. recycling system.

Other types of polyethylene include “medium-density polyethylene” (MDPE), which typically have a density from about 0.925 g/cm³ to less than about 0.94 g/cm³ and “low-density polyethylene” (LDPE), which typically refers to branched homopolymers having densities between about 0.91 g/cm³ to less than about 0.925 g/cm³. Examples include ethylene vinyl acetate copolymer (EVA), polyvinyl chloride (PVC), polypropylene (PP), polystyrene (PS), and polylactic acid (PLA).

A “layer” as used herein refers to a building block of films that is a structure of a single material type or a blend of materials. A layer may be a single polymer, a blend of materials within a single polymer type or a blend of various polymers, may contain metallic materials and may have additives. Layers may be continuous with the film or may be discontinuous or patterned.

An “outer surface” or “outer film” as used herein refers to the portion of a film or layer that is intended to be oriented toward the exterior of a package (i.e., away from the packaged product) when the film is used as a packaging film.

An “inner surface” or “inner layer” or “inner film” as used herein refers to the surface or layer of the film that is oriented opposite of the outer surface or outer layer. In other words, “inner” refers to the orientation away from the outer surface and toward the interior of a package (i.e., toward the packaged product) when the film is used as a packaging film.

As used herein, the term “recyclable” is meant to indicate that the film can be converted into a new useful item, by means of reprocessing in a polyethylene waste stream. Reprocessing may entail washing, separating, melting and forming, among many other steps. Typically, when plastic packaging is reprocessed, the material is mechanically chopped into small pieces and then melted to be reformed into the new product. If multiple incompatible materials are present in the packaging, interactions occur during reprocessing causing gels, brittle material, poor appearance and generally unusable or poor-quality products. Using the term “recyclable” indicates that these drawbacks are generally not present. Most plastic items are labeled with a recycling symbol with a number 1-7 in the center, indicating the Society of Plastics Industry (SPI) codes to help identify and sort various plastics for recycling. Number 2 plastics are HDPE-based and are commonly collected in residential and community recycling programs. Plastic recycling codes 1 (polyethylene terephthalate-based), 2 (HDPE-based), 5 (polypropylene-based) and 6 (polystyrene-based) represent plastics that are commonly recycled and collected in residential and community recycling collection programs. Number 4 (low-density polyethylene-based) plastics are used in plastic grocery bags can be recycled through grocery store collections. Number 3 (vinyl or polyvinyl chloride-based) and 7 (other) plastics are more difficult to recycle and generally not collected in public programs. In some embodiments, the packaging films described herein can be fully recyclable under SPI Code 2. This advantageously allows for recycling of the entire packaging film without the need to separate components into recyclable and non-recyclable parts for disposal into recycling and waste streams, respectively.

The packaging film can be at least 90% HDPE. In some embodiments, the packaging film can be at least 90%, 91%, 92%, 93%, 94%, 95%, 96%, 97%, 98%, 99% or 100% HDPE, or a range between any two of the preceding values. In some embodiments, the outer base film can consist essentially of HDPE, containing only minimal amounts of non-HDPE materials that do not materially affect the basic and novel characteristics of the film. In some embodiments, the packaging film contains less than 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% by weight, or does not include one or more of the following: linear low-density polyethylene, low-density polyethylene, polyvinyl chloride (PVC), polypropylene (PP), polystyrene (PS), and polylactic acid (PLA).

The oxygen transmission rate (OTR) of the packaging film can be analyzed according to standard testing protocols known in the art, such as ASTM D 3985, ASTM F1927, and ISO 15105-2, and on instruments such as MOCON OX-TRAN 2/22. The coulometric method directly measures the amount of oxygen that permeates through the film using an electrochemical sensor. The sample is mounted in a test chamber, with one side exposed to an oxygen-containing gas and the other side to an inert gas (e.g., nitrogen). Oxygen that permeates through the film is captured by the sensor, which generates an electrical signal. The system calculates the OTR based on the strength of the electrical signal.

In some embodiments, the packaging film has a OTR of less than 1 cm³/m² per 24 hours. In some embodiments, the OTR can be about or less than about 0.95, 0.9, 0.85, 0.8, 0.75, 0.7, 0.65, 0.6, 0.55 or 0.5 cm³/m² per 24 hours, or can be less than an amount between any two of these values (such as less than 0.66 cm³/m² per 24 hours). In some embodiments, the OTR is from about 0.01 cm³/m² to about 0.95 cm³/m² per 24 hours, from about 0.05 cm³/m² to about 0.9 cm³/m² per 24 hours, from about 0.1 cm³/m² to about 0.85 cm³/m² per 24 hours, from about 0.15 cm³/m² to about 0.8 cm³/m² per 24 hours, from about 0.2 cm³/m² to about 0.75 cm³/m² per 24 hours, or from about 0.25 cm³/m² to about 0.7 cm³/m² per 24 hours. In one embodiment, the OTR is from 0.17 cm³/m² per 24 hours to 0.66 cm³/m² per 24 hours.

The water vapor transmission rate (WVTR) of the packaging film can be analyzed according to standard testing protocols known in the art, such as ASTM F 1249, and on instruments such as MOCON PERMATRAN-W 3/34. The infrared sensor method is widely used in the research and development of packaging materials, especially in fields such as food, pharmaceuticals, and electronics packaging. The method uses infrared sensors to detect the water vapor concentration on either side of the film, allowing for the calculation of the WVTR. The sample is mounted in a test chamber with controlled sections: one with constant humidity and another for measuring transmitted vapor. The infrared sensors continuously monitor the amount of water vapor permeating through the film, and the system calculates the WVTR value. The WVTR can also be determined by other methods, such as the gravimetric method or cup method. The gravimetric method determines WVTR by measuring the moisture absorbed by a desiccant over time. The method is as follows: the sample is fixed on a sealed container filled with a desiccant, exposing one side of the film to a high-humidity environment; water vapor permeates through the film and is absorbed by the desiccant inside the container; the weight of the container is monitored over time to determine the amount of absorbed water; WVTR is calculated based on the absorbed moisture and testing duration. The cup method is as follows: the sample is sealed over a cup containing either water (wet cup) or a desiccant (dry cup); the cup is placed in a controlled environment with constant temperature and humidity; water vapor passes through the film from the higher humidity side to the lower humidity side; the weight of the cup is monitored over time to determine the amount of transmitted water vapor; WVTR is calculated based on the transmitted moisture and testing duration.

In some embodiments, the packaging film has a WVTR of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0 g/m² per 24 hours, or can be within a range between any two of the foregoing values. For example, in some embodiments WVTR is from about 0.1 g/m² per 24 hours to about 3.0 g/m² per 24 hours. In some embodiments, the WVTR is from about 1.0 g/m² per 24 hours to about 3.0 g/m² per 24 hours.

In some embodiments, the thickness of the packaging film can be about 10, 15, 20, 25, 30, 35, 40, 45, 50, 55, 60, 65, 70, 75, 80, 85, 90, 95, 100, 125, 150, 175, or 200 μm, or can be within a range between any two of the foregoing values. For example, in some embodiments, the thickness of the packaging film can be from about 15 μm to about 200 μm.

In some embodiments, the density of the packaging film can be from about 0.94 g/cm³ to about 1 g/cm³, such as from about 0.94 g/cm³ to about 0.99 g/cm³, from about 0.94 g/cm³ to about 0.98 g/cm³, from about 0.94 g/cm³ to about 0.97 g/cm³, from about 0.94 g/cm³ to about 0.96 g/cm³, from about 0.94 g/cm³ to about 0.95 g/cm³, from about 0.95 g/cm³ to about 1 g/cm³, from about 0.95 g/cm³ to about 0.99 g/cm³, from about 0.95 g/cm³ to about 0.98 g/cm³, from about 0.95 g/cm³ to about 0.97 g/cm³, from about 0.95 g/cm³ to about 0.96 g/cm³, from about 0.96 g/cm³ to about 1 g/cm³, from about 0.96 g/cm³ to about 0.99 g/cm³, from about 0.96 g/cm³ to about 0.98 g/cm³, from about 0.96 g/cm³ to about 0.97 g/cm³, from about 0.97 g/cm³ to about 1 g/cm³, from about 0.97 g/cm³ to about 0.99 g/cm³, from about 0.97 g/cm³ to about 0.98 g/cm³, from about 0.98 g/cm³ to about 1 g/cm³, from about 0.98 g/cm³ to about 0.99 g/cm³, or from about 0.99 g/cm³ to about 1 g/cm³. In an embodiment, the density of the packaging film can be from 0.940 g/cm³ to 0.965 g/cm³.

The physical strength of the packaging film can be described by various measurements. For example, tear strength is a measurement of the force required to tear a film and can be measured in the machine direction (MD), referring to the direction that a material unwinds as it is being fed into a press, tunnel, or other device, or in the transverse direction (TD), referring to the direction that is 90-degrees to the machine direction. In some embodiments, the tear strength of the packaging film in the MD can be about 2, 3, 4, 5, 6, 7, 8, 9, 10, 11, 12, 13, or 14 N, or can be within a range between any two of the foregoing values. In some embodiments, the tear strength of the packaging film in the TD can be about 4, 5, 6, 7, 8, 9, 10, 11, 12, 13, 14, 15, 16, 17, 18, 19, or 20 N, or can be within a range between any two of the foregoing values. In some embodiments, the tear strength in the MD can be about 8 N and the tear strength in the TD can be about 11 N.

The physical strength of the packaging film can be measured as elongation at break in the MD or TD. In some embodiments, the elongation at break of the packaging film in the MD can be about 100%, 110%, 120%, 130%, 140%, 150%, 160%, 170%, 180%, 190%, 200%, 210%, 220%, 230%, 240%, 250%, 260%, 270%, or 280%, or can be within a range between any two of the foregoing values. In some embodiments, the elongation at break of the packaging film in the TD can be about 50%, 51%, 52%, 53%, 54%, 55%, 56, 57%, 58%, 59%, or 60%, or can be within a range between any two of the foregoing values. In some embodiments, the elongation at break in the MD can be about 190% and the elongation at break in the TD can be about 55%.

The physical strength of the packaging film can also be measured as tensile strength in the MD or TD, which describes the stress a material can withstand without permanent deformation. In some embodiments, the tensile strength of the packaging film in the MD can be about 30, 31, 32, 33, 34, 35, 36, 37, 38, 39, 40, 41, 42, 43, 44, 45, 46, 47, 48, 49, or 50 MPa, or can be within a range between any two of the foregoing values. In some embodiments, the tensile strength of the packaging film in the TD can be about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 MPa, or can be within a range between any two of the foregoing values. In some embodiments, the tensile strength in the MD can be about 42 MPa and the tensile strength in the TD can be about 68 MPa.

The physical strength of the packaging film can also be measured as impact resistance strength, which is a measure of the energy absorbed by a material when exposed to an impact force (such as a pendulum) before it breaks. In some embodiments, the anti-pendulum impact strength of the packaging film can be about 0.6, 0.7, 0.8, 0.9, 1.0, 1.1, 1.2, 1.3, 1.4, 1.5, 1.6, 1.7, 1.8, 1.9, or 2.0 J, or can be within a range between any two of the foregoing values. In some embodiments, the anti-pendulum impact strength can be about 1.2 J.

In some embodiments, the melting onset temperature of the packaging film can be about 110, 111, 112, 113, 114, 115, 116, 117, 118, 119, 120, 121, 122, 123, 124, 125, 126, 127, 128, 129, or 130° C., or can be within a range between any two of the foregoing values. In some embodiments, the melting peak temperature of the packaging film can be about 125, 126, 127, 128, 129, 130° C., or can be within a range between any two of the foregoing values. In some embodiments, the melting end temperature of the packaging film can be about 133, 134, 135, 136, or 137° C., or can be within a range between any two of the foregoing values.

The outer base film can be at least 90% HDPE. In some embodiments, the outer base film can be at least 90%, 91%, 92%, 93%, 94%, 95%, 96%, 97%, 98%, 99% or 100% HDPE. In some embodiments, the outer base film can consist essentially of HDPE, containing only minimal amounts of non-HDPE materials that do not materially affect the basic and novel characteristics of the film. For example, the outer base film may contain additives such as slip, antiblock or processing aids, as are known by one skilled in the art of film extrusion, for purposes of converting. Additionally, the base film may contain additives such as nucleating agents for manipulation of the physical properties of the film. In some embodiments, the outer base film does not include one or more of the following: linear low-density polyethylene, low-density polyethylene, polyvinyl chloride (PVC), polypropylene (PP), polystyrene (PS), and polylactic acid (PLA).

In some embodiments, the outer base film can include HDPE in the form of a linear HDPE film, a high-density machine-direction orientation polyethylene (HD-MDOPE) film, a high-density biaxially orientated polyethylene (HD-BOPE) film, a high-density cast polyethylene (HD-CPE) film, an alumina coated HDPE film, an alumina coated HD-MDOPE film, an alumina coated HD-BOPE film, and an alumina coated HD-CPE film, and combinations thereof. In some embodiments, the outer base film can include HD-MDOPE. In some embodiments, the outer base film can include HD-BOPE. In some embodiments, the outer base film can include HD-CPE.

In some embodiments, the outer base film can be formed by a blown film process with 1, 2, 3, 5, 7, 9 or 11 layers. In some embodiments, the outer base film can include one or more HDPE films bonded together with an adhesive. In some embodiments, the adhesive can be a glue adhesive or a tie material. A tic material, sometimes referred to as a tie-layer, assists in adhesion between layers of materials such as nylon, paper, metals, EVOH, or other polymers. In some embodiments, the thickness of the outer base film can be about 10, 15, 20, 25, 30, 35, 40, 45, 50, 55, 60, 65, 70, 75, 80, 85, 90, 95, 100, 125, 150, 175, or 200 μm, or can be within a range between any two of the foregoing values. For example, in some embodiments, the thickness of the outer base film can be from about 15 μm to about 200 μm. In some embodiments, the density of the outer base film can be from about 0.94 g/cm³ to about 1 g/cm³, such as from about 0.94 g/cm³ to about 0.99 g/cm³, from about 0.94 g/cm³ to about 0.98 g/cm³, from about 0.94 g/cm³ to about 0.97 g/cm³, from about 0.94 g/cm³ to about 0.96 g/cm³, from about 0.94 g/cm³ to about 0.95 g/cm³, from about 0.95 g/cm³ to about 1 g/cm³, from about 0.95 g/cm³ to about 0.99 g/cm³, from about 0.95 g/cm³ to about 0.98 g/cm³, from about 0.95 g/cm³ to about 0.97 g/cm³, from about 0.95 g/cm³ to about 0.96 g/cm³, from about 0.96 g/cm³ to about 1 g/cm³, from about 0.96 g/cm³ to about 0.99 g/cm³, from about 0.96 g/cm³ to about 0.98 g/cm³, from about 0.96 g/cm³ to about 0.97 g/cm³, from about 0.97 g/cm³ to about 1 g/cm³, from about 0.97 g/cm³ to about 0.99 g/cm³, from about 0.97 g/cm³ to about 0.98 g/cm³, from about 0.98 g/cm³ to about 1 g/cm³, from about 0.98 g/cm³ to about 0.99 g/cm³, or from about 0.99 g/cm³ to about 1 g/cm³. In an embodiment, the density of the outer base film can be from 0.940 g/cm³ to 0.965 g/cm³.

The outer base film may contain material that has been recovered, such as post-consumer recycled (PCR) content or post-industrial recycled (PIR) content. Such materials can contribute to the overall material content targets of the film such that they are not detrimental to the recyclability or overall performance of the film.

In some embodiments, the outer base film can be 100% HDPE. In some embodiments, the outer base film can be selected from the group consisting of a linear HDPE film, a high-density machine-direction orientation polyethylene (HD-MDOPE) film, a high-density biaxially oriented polyethylene (HD-BOPE) film, a high-density cast polyethylene (HD-CPE) film, an alumina coated HDPE film, an alumina coated HD-MDOPE film, an alumina coated HD-BOPE film, an alumina coated HD-CPE film, and combinations thereof.

In some embodiments, the outer base film can also include an adhesive, printed indicia and other additives, such that the non-HDPE materials are collectively less than 10% of the overall weight of the packaging film. In some embodiments, the non-HDPE materials can be less than 10%, 9%, 8%, 7%, 6%, 5%, 4%, 3%, 2% or 1% of the overall weight of the packaging film.

The packaging film can be fabricated by any known process or combination of processes, such as co-extrusion blown film, casting, lamination (such as dry lamination, solvent-free lamination, or extrusion lamination), glue compounding, or another process as described herein. The extrusion process may be single-layer or multilayer. Single-layer and multilayer extrusion processes can both form a single layer of film. Multilayer may be achieved through a single co-extrusion process, or successive extrusion lamination or extrusion coating operations. Extrusion may be performed on dies that are annular, flat or any other configuration.

A typical blown film process can be used to extrude the outer base film. The resultant annular tube can collapse upon itself while still warm, creating a single palindromic structure. Alternatively, the tube can be slit and wound onto two separate rolls. Prior to slitting and winding the films, the film can be oriented and annealed in line, using monoaxial or biaxial orientation in a double or triple bubble process, as is known in the art. Alternatively, the processes of orientation and annealing may be done in an off-line process. Optionally, irradiative crosslinking may also be completed either in-line with extrusion or off-line and either prior to or after orientation.

The outer base film can be extruded in a flat die configuration. As with annular extrusion the film can be oriented, annealed and optionally irradiated, either in-line or off-line. Orientation can be machine direction only, transverse direction only, or both machine and transverse direction. When stretching the film in a machine direction orientation (MDO) process, orientation of 2 to 8 times is typical, depending on the film formulation and properties required.

After orientation, the outer base film can be annealed to reduce the amount of shrink the film will have under heated conditions. Annealing is typically accomplished in-line, directly following orientation, through high diameter rollers heated to temperatures a few degrees lower than the melting point of the polymer or blend of polymers present in the film. However, annealing can be done by any known means, including hot air or IR heating.

Reducing the shrinkage rate can be advantageous for further processing (i.e., printing or laminating) and improving the appearance of the recyclable film when it is heat scaled in a packaging operation. In some embodiments, the outer base film can have a free shrinkage rate in the machine direction of less than 10% when exposed to heat at about or less than about 90° C., or less than 9%, less than 8%, less than 7%, less than 6%, less than 5%, less than 4%, less than 3%, less than 2%, or less than 1%. In some embodiments, the outer base film can have a free shrinkage rate in the transverse direction of less than 10% when exposed to heat at about or less than about 90° C., or less than 9%, less than 8%, less than 7%, less than 6%, less than 5%, less than 4%, less than 3%, less than 2%, or less than 1%. In some embodiments, the outer base film can have a machine direction shrinkage rate of less than 7% and a transverse direction shrinkage rate of less than 7%, when exposed to heat at about or less than about 90° C. In some embodiments, the outer base film can have a machine direction shrinkage rate of less than 7% and a transverse direction shrinkage rate of less than 1%, when exposed to heat at about or less than about 90° C. In some embodiments, the outer base film can have a machine direction shrinkage rate of less than 5% and a transverse direction shrinkage rate of less than 5%, when exposed to heat at about or less than about 90° C. In some embodiments, the outer base film can have a machine direction shrinkage rate of less than 2% and a transverse direction shrinkage rate of 0%, when exposed to heat at about or less than about 90° C. In some embodiments, the outer base film can have a machine direction shrinkage rate of less than 1% and a transverse direction shrinkage rate of 0%, when exposed to heat of about or less than about 90° C. In some embodiments, the outer base film can include HD-MDOPE or HD-BOPE, and the outer base film can have a free shrinkage rate of less than 7% in the machine direction and less than 7% in the transverse direction when heated to 90° C.

The outer base film may have a transparency of more than 70%. In some embodiments, the base film has a transparency of at least 70%, 75%, 80%, 85%, 90%, or 95%, and all values there between, when measured in accordance with the instructions and teachings of ASTM D-1003-13. In an embodiment, the base film has a transparency of at least 80%. In an embodiment, the base film has a transparency of between 80% and 95%. Transparency is the percentage of transmitted light that deviates from the incident light by less than 2.5 degrees. The transparency of the base film can be affected by material selection and orientation conditions, as is known in the art. For instance, it is generally known that machine direction orientation of HDPE films to a level of 4-5× will significantly improve the transparency over films that have had less orientation. Alternatively, the base film could be opaque or have any transparency level in between high transparency and opaque.

The outer base film may have the surfaces treated for various reasons. Corona treatment may be applied to either surface of the base film as may be needed for printing or adhesive lamination. Surface coatings may be added to enhance the slip properties of the exterior surface. In some embodiments, other coatings and treatments may be added to the packaging film.

The packaging films described herein have a barrier material located between the outer base film and the inner scaling film. The barrier material can be any material that prevents transmission of a migrating component such as oxygen or moisture. Advantageously, the packaging films have barrier levels suitable for providing protection for packaged products that may be sensitive to oxygen or moisture. The packaging films slow transmission of oxygen or moisture to help maintain the quality of the product packaged therein, extending the shelf-life.

One example of a suitable barrier material is one that slows the transmission of oxygen. The barrier material, when applied to a film, may limit the oxygen transmission through that film to less than 1 cm³/m² per 24 hours. For some food applications, the preferred oxygen transmission rate of a packaging film can be less than 1 cm³/m² per 24 hours.

Another example of a suitable barrier material is one that slows the transmission of moisture. The barrier material, when applicated to a film, may have water vapor transmission rates of less than 3 g/m² per 24 hours. In some embodiments, the packaging film can have a barrier material that provides low transmission of both oxygen and moisture.

In some embodiments, the barrier material can be applied to the inner layer of the outer base film. In another embodiment, the barrier material can be applied to the outer surface of the inner sealing layer (i.e., opposite of the exposed inner sealing film surface). In other embodiments.

The barrier material can be chosen from a wide variety of coatable materials. The barrier material may behave like an adhesive that serves to adhere adjacent layers of the structure to each other. The barrier material can be an adhesive. The barrier material can be selected to provide the desired barrier level (low transmission rate) at a low coating weight such that the barrier material will not over-contaminate the recycling process. Additionally, certain materials, such as chlorinated barrier materials, may need to be avoided as even small amounts of these materials may contaminate the recycling process. In some embodiments, the barrier material can include polyvinyl alcohol (PVA) or ethylene vinyl alcohol (EVOH).

In some embodiments, the barrier material can have a thickness from about 0.5 μm to about 20 μm.

Non-limiting examples of barrier materials that may be suitable for a packaging film are polyvinylidene chloride latexes (such as Saran™ from Dow), polyalcohols (such as Nichigo G-Polymer™ from Nippon Gohsei), exfoliated clay nano composites (such as Sunbar, available from SunChemical), polyacrylate based materials (such as those used on Besela™ high-barrier films, available from Toppan), or inorganic coatings such as aluminum oxide. In some embodiments, a barrier material is one that does not contain chlorine, has high transparency, provides high barrier under a wide variety of conditions, and has good flex crack resistance. However, any thin barrier material may be chosen to match the performance requirements of the application in which it will be used. Because most barrier materials do not include polyethylene, the content of the barrier material in the recyclable film should be minimized such that the total non-polyethylene portion of the film is present at a mass that is less than 10% of the total film mass. Depending on the total composition of the film, non-polyethylene components may be polymer additives (such as slip or antiblock), adhesives, inks, or other components. Each of these sources should be minimized to case recyclability. In some embodiments, the barrier material may be present in the packaging film at mass levels less than 10%, less than 5%, less than 4%, less than 3%, less than 2% or less than 1% of the total film structure mass. In some cases, the recycling process may accept non-polyethylene levels greater than 5%, in which case the mass of barrier material may be higher than 5%.

The barrier material may be applied in any known method including extrusion, flood coating, gravure printing, slot die coating, etc. Due to the requirement that the barrier material be provided in a very small amount, in some embodiments the barrier material is coated or printed, as these processes can achieve very thin layers. The barrier material can be applied directly to the surface of the base film, directly to the surface of the sealant, directly to the surface of another film, or directly to the surface of any of these material which has been previously coated with another material such as adhesive, primer or ink. In some embodiments, the barrier material is applied to the surface of a primer which has been applied to the inner surface of the inner layer of the base film.

The barrier material may be applied in a continuous layer, co-continuous with the base film, or it may be patterned. The pattern may be invisible to the naked eye. The pattern may apply barrier to certain sections of the film and leave other sections of the film without harrier. The barrier material may be applied in varying amounts such that different areas of the film have different transmission rates. The barrier material may be applied in a continuous layer, providing a consistent transmission rate across the entirety of the film.

In some embodiments, the packaging film can be printed with indicia or have other type of markings applied. The indicia or marking can be applied to the film in any position of the film structure and by any means, such as, but not limited to, flexographic printing or laser marking. The indicia or marking may be visible from either or both sides of the film. In some embodiments, the packaging film can have indicia that is a result of ink printed by any process typical to flexible film converting, including, but not limited to, flexographic printing, rotogravure printing or digital printing. The indicia can be printed on the outer surface of the film or may be between other layers and materials of the film. In some embodiments the indicia can be between the outer base film and the inner sealing film. In some embodiments, the indicia may be applied directly to the surface of the barrier material and may be visible from both sides of the film.

An inner sealing film can be connected to an outer base film to form the packaging film such that a barrier material is located between the outer base film and the inner scaling film. The inner sealing film can be connected to the outer base film by any known method including, but not limited to, co-extrusion, lamination, or coating. In some embodiments, there can be an adhesive layer between the outer base film and the inner sealing film. In some embodiments, there can be an adhesive layer between the inner scaling layer and the barrier material, wherein the adhesive layer can also be in contact with the optional indicia.

The inner scaling film can include HDPE (such as a linear HDPE film, a high-density machine-direction orientation polyethylene (HD-MDOPE) film, a high-density biaxially oriented polyethylene (HD-BOPE) film, a high-density cast polyethylene (HD-CPE) film, an alumina coated HDPE film, an alumina coated HD-MDOPE film, an alumina coated HD-BOPE film, an alumina coated HD-CPE film, and combinations thereof) and metallocene polyethylene (mPE). In some embodiments, the inner sealing film can be single-layer or multilayer. In the case of multilayer material, the surface layer or more than one layer may be intricately involved in sealing. If the inner scaling film is multilayer, it may contain other materials as long as they do not frustrate the recycling intent for the packaging film.

In some embodiments, the packaging film does not include polyvinyl chloride, low-density polyethylene, polypropylene, polystyrene, or polylactic acid. When it states that the film does not contain certain material, it refers to the weight percentage of such material is below certain threshold or detection level. For example, the weight percentage of such material is less than 0.1%, 0.09%, 0.08%, 0.07%, 0.06%, 0.05%, 0.04%, 0.03%, 0.02%, 0.01%, 0.005%, or 0.001% of the total weight of the packaging film.

In some embodiments, the inner sealing film can be manufactured by a blown film process with 1, 2, 3, 5, 7, 9 or 11 layers. In some embodiments, the blown film process can include 1, 2, 3, or 5 layers.

In some embodiments, the inner sealing film may be a material applied as a heat seal coating. Heat seal coatings are typically thin and may be pattern-applied. Heat seal coatings may contain low melt temperature components such as waxes. In some embodiments, the outer base film can be heat resistant such that the packaging film does not shrink or otherwise distort when exposed to scaling conditions. Additionally, in some embodiments, the inner sealing film may soften and seal at a relatively low temperature, further avoiding distortion issues. In other words, the heat-resistant base film can have higher heat resistance as compared to the temperature at which the inner scaling film is capable of making a seal, such that there is an operating window in which the seals can be made without compromising the appearance or other performance properties of the packaging film.

Heat seal coatings that contain wax components may have heat seal initiation temperatures of 60° C. or even lower. Extended polyethylene-based sealant films may have heat seal initiation temperatures of 85° C. or even lower. In some embodiments, the sealant on the packaging film may have a heat seal initiation temperature that is less than 60° C., 85° C., 100° C. or 121° C.

Between the inner sealing film and the outer base film, any number of optional films or layers may be provided. For example, in some embodiments, there may be an adhesive layer, printed indicia, or a barrier layer between the inner sealing film and the outer base film. In some embodiments, any further layers other than the inner sealing layer may contain recycled materials. In some embodiments, the inner sealing layer does not contain recycled materials, so as to avoid contamination of food-grade material stored in the packaging with non-food grade recycled materials. Recycled materials may include post-consumer recycled (PCR) content or post-industrial recycled (PIR) content. If used, these materials contribute to the overall material content targets such that they are not detrimental to the recyclability or overall performance of the packaging film.

In some embodiments, there may be a second sealing layer located on the opposite side of the outer base film from the first sealing film. This type of film could be used for packaging applications that require lap seal configurations (i.e., one side of the film is heat sealed to the opposite side of the film).

In some embodiments, the outer base film and the barrier material can be bonded together by a coating process. In some embodiments, the outer base film and the barrier material can be bonded together through a co-extrusion blown film process, which can include using 2 layers of tic material.

In some embodiments, the inner sealing film and the barrier material can be bonded together by a coating process. In some embodiments, the inner sealing film and the barrier material can be bonded together through a co-extrusion blown film process, which can include using 2 layers of tic material.

In some embodiments, the packaging films as described herein may be used as-formed to fabricate packages. When the packaging films are used to fabricate packages, the inner surface of the packaging film can be of a composition or treated to be a sealant. In some embodiments, the packaging films can include markings on the outer surface or, for multilayered packaging films, can be on either side of the outer base film. In some embodiments, the markings can be made by indentation. In some embodiments, the markings can be made by ink. In other embodiments, the markings are not made by ink.

In some embodiments, a package can be formed from a packaging film described herein. In some embodiments, the package can be in a form selected from a pouch, a bag, and a bag-in-box liner. Non-limiting examples of a pouch include a three-side seal bag, a stand-up pouch, a zipper pouch, a stand-up zipper pouch, a box pouch, and a box zipper pouch. Non-limiting examples of a bag include a pillow bag, a back-seal gusset bag, a side gusset bag, a quad seal bag. In some embodiments, the package can include a seal, a zipper, a nozzle, a cap, or a spout. In some embodiments, the packaging can be in the shape of a box, a bottle (such as a wine bottle), or another defined shape. In some embodiments, the packaging film of the package can be flexible. In some embodiments, the packaging film of the package can be rigid enough to maintain an upright position (stand-up) without additional support. In some embodiments, the package can be suitable for liquid storage. In some embodiments, to form a package, an inner sealing film as disclosed herein can be adhered to itself or another packaging component to form a scam of a package. In some embodiments, a packaging film described herein may be heat sealed to other films to make packages. In some embodiments, the outer surface of the outer base film can be irradiated to form crosslinks in at least an outer surface of the outer base film.

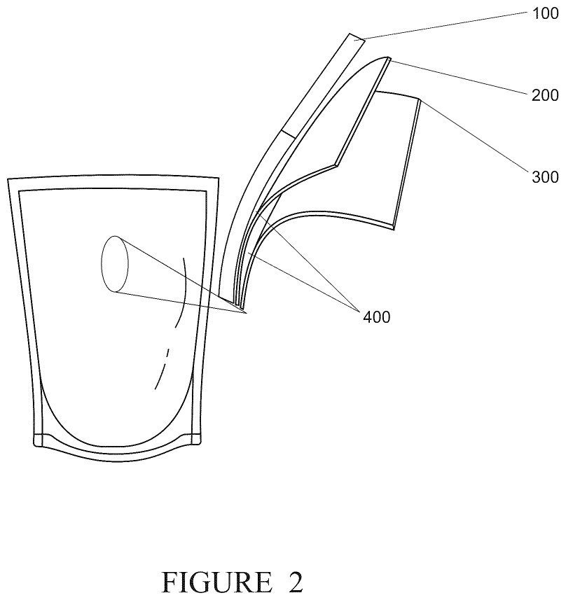

FIG. 2 is an example package made from a packaging film as described herein. The packaging film includes an outer base film 100 made of HDPE, a barrier material 200, an inner sealing film 300 made of HDPE, and adhesive layers 400 between the outer base film and the barrier material and between the barrier material and the inner scaling film. In some non-limiting embodiments, the adhesive layers 400 can be glue or a tie material. When used in a packaging application, the packaging film may be aligned such that the inner scaling film 300 becomes the inner layer of the package, in closest proximity to the packaged item (i.e., product) with respect to the other components of the film.

In some embodiments, a packaging component, such as a lid or a spout, can be included in the package formed from a packaging film as described herein. In some embodiments, the packaging component, such as a lid or a spout, can be formed from a packaging film as described herein or can be a multilayered film that includes a packaging film as described herein. In general terms, there is at least an outer base film, an inner sealing film and a barrier material located between the outer base film and the inner sealing film. Optionally, one or more additional layers may be present between the outer base film and the inner scaling film.

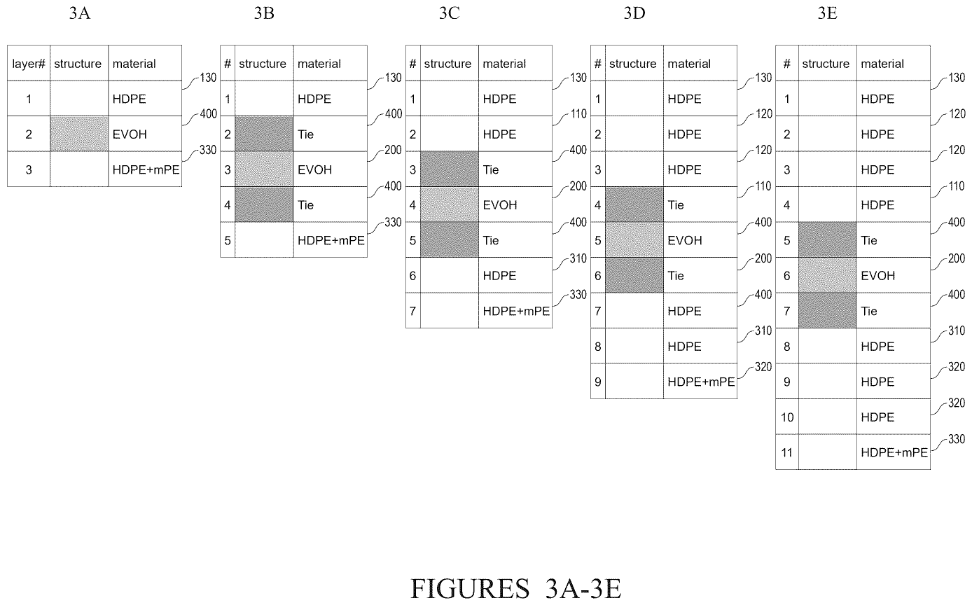

Examples of packaging film designs are shown in FIGS. 3A-3E, which are not intended to be limiting. One or both of the outer base film and the inner scaling film can be single-layer or multilayer. As described herein, in some embodiments, the outer base film 100 can be a single base film layer of HDPE 130, can be an outer-most base film layer of HDPE 130 and an additional base film layer 110 of HDPE, or can be an outer-most base film layer of HDPE 130 with one or more additional base film layer(s) 120 of HDPE and an additional base film layer 110 of HDPE in contact with an adhesive 400. As described herein, in some embodiments, the inner sealing film 300 can be a single inner sealing film layer of HDPE+mPE 330, can be an inner-most inner sealing film layer of HDPE+mPE 330 and an additional inner sealing film layer 310 of HDPE, or can be an inner-most inner sealing film layer of HDPE+mPE 330 with one or more additional inner sealing film layer(s) 320 of HDPE and an additional inner sealing film layer 310 of HDPE in contact with an adhesive 400. In further embodiments, the outer base film layer(s) can be or include HD-MDOPE, HD-BOPE, or HD-CPE, or the inner scaling film layer(s) can be or include HD-CPE. Additional examples are described herein, which are not intended to be limiting.

In any embodiments of the packaging films described herein, the description of the various layers is in the direction from outer-most base film to inside sealing film in the left to right direction. In one embodiment, the packaging film can have the following design: HDPE/EVOH/HDPE+mPE, as shown in FIG. 3A. FIG. 3A shows an outer-most base film layer of HDPE 130, a barrier material 200 of EVOH, and an inner-most inner scaling film layer of HDPE+mPE 330. In other embodiments described throughout, the barrier material 200 can be PVA//Adh//. For example, in an embodiment, the packaging film can have the following design: HDPE/PVA//Adh//HDPE+mPE. In another embodiment, the packaging film can have the following design: HDPE/Tic/EVOH/Tic/HDPE+mPE, as shown in FIG. 3B. FIG. 3B shows an outer-most base film layer of HDPE 130, an adhesive 400 made of a Tic layer, a barrier material 200 of EVOH, an adhesive 400 made of a Tie layer, and an inner-most inner sealing film layer of HDPE+mPE 330. In another embodiment, the packaging film can have the following design: HDPE/HDPE/Tic/EVOH/Tic/HDPE/HDPE+mPE, as shown in FIG. 3C. FIG. 3C shows an outer-most base film layer of HDPE 130, an additional base film layer 110 of HDPE in contact with an adhesive 400 made of a Tie layer, a barrier material 200 of EVOH, an adhesive 400 made of a Tie layer in contact with an additional inner sealing film layer 310 of HDPE, and an inner-most inner scaling film layer of HDPE+mPE 330. In another embodiment, the packaging film can have the following design: two layers of HDPE/EVOH/HDPE+mPE glue compounded together. In another embodiment, the packaging film can have the following design: HDPE/HDPE/HDPE//Tic/EVOH/Tic/HDPE/HDPE/HDPE+mPE, as shown in FIG. 3D. FIG. 3D shows an additional base film layer 120 of HDPE and an additional inner sealing film layer 320 of HDPE, as compared to FIG. 3C. In another embodiment, the packaging film can have the following design: HDPE/HDPE/HDPE/HDPE/Tic/EVOH/Tic/HDPE/HDPE/HDPE/HDPE+mPE, as shown in FIG. 3E.

FIG. 3E shows an additional two base film layers 120 of HDPE and an additional two inner sealing film layers 320 of HDPE, as compared to FIG. 3C. In another embodiment, the packaging film can have the following design: two layers of HDPE/Tic/EVOH/Tic/HDPE+mPE glue compounded together.

In some embodiments, the packaging film can include HD-MDOPE. In an embodiment, the packaging film can have the following design: HD-MDOPE//Adh//HDPE+mPE. In another embodiment, the packaging film can have the following design: HD-MDOPE/PVA//Adh//HDPE+mPE, coated with PVA, glue, and HDPE film. In another embodiment, the packaging film can have the following design: HD-MDOPE//Adh//HDPE/EVOH/HDPE+mPE. In another embodiment, the packaging film can have the following design: HD-MDOPE//Adh//HDPE/Tic/EVOH/Tic/HDPE+mPE. In another embodiment, the packaging film can have the following design: HD-MDOPE//Adh//HDPE/HDPE/Tic/EVOH/Tic/HDPE/HDPE+mPE. In another embodiment, the packaging film can have the following design: HD-MDOPE//Adh//HDPE/HDPE/HDPE/Tic/EVOH/Tic/HDPE/HDPE/HDPE+mPE. In another embodiment, the packaging film can have the following design: HD-MDOPE//Adh//HDPE/HDPE/HDPE/HDPE/Tic/EVOH/Tic/HDPE/HDPE/HDPE/HDPE+mPE.

In some embodiments, the outer base film can include HD-BOPE. In an embodiment, the packaging film can have the following design: HD-BOPE//Adh//HDPE+mPE. In another embodiment, the packaging film can have the following design: HD-BOPE/PVA//Adh//HDPE+mPE, coated with PVA, glue, and HDPE film. In another embodiment, the packaging film can have the following design: HD-BOPE//Adh//HDPE/EVOH/HDPE+mPE. In another embodiment, the packaging film can have the following design: HD-BOPE//Adh//HDPE/Tic/EVOH/Tic/HDPE+mPE. In another embodiment, the packaging film can have the following design: HD-BOPE//Adh//HDPE/HDPE/Tic/EVOH/Tic/HDPE/HDPE+mPE. In another embodiment, the packaging film can have the following design: HD-BOPE//Adh//HDPE/HDPE/HDPE/Tic/EVOH/Tic/HDPE/HDPE/HDPE+mPE. In another embodiment, the packaging film can have the following design: HD-BOPE//Adh//HDPE/HDPE/HDPE/HDPE/Tic/EVOH/Tic/HDPE/HDPE/HDPE/HDPE+mPE.

In some embodiments, the packaging film can include HD-CPE, achieved through a co-extrusion casting process. In some embodiments, the HD-CPE packaging film can have the following design: HDPE/EVOH/HDPE+mPE. In some embodiments, the HD-CPE packaging film can have the following design: HDPE/Tic/EVOH/Tic/HDPE+mPE. In some embodiments, the HD-CPE packaging film can have the following design: HDPE/HDPE/Tic/EVOH/Tic/HDPE/HDPE+mPE. In some embodiments, the HD-CPE packaging film can have the following design: two layers of HDPE/EVOH/HDPE+mPE bonded with adhesive. In some embodiments, the HD-CPE packaging film can have the following design: HDPE/HDPE/HDPE/Tic/EVOH/Tic/HDPE/HDPE/HDPE+mPE. In some embodiments, the HD-CPE packaging film can have the following design: HDPE/HDPE/HDPE/HDPE/Tic/EVOH/Tic/HDPE/HDPE/HDPE/HDPE+mPE. In some embodiments, the HD-CPE packaging film can have the following design: two layers of HDPE/Tic/EVOH/Tic/HDPE+mPE bonded with adhesive.

In some embodiments, when the packaging film includes HD-CPE, the packaging film can have the following design: HDPE/PVA//Adh//HD-CPE, wherein the HD-CPE is formed by a 3-, 5-, 7-, 9- or 11-layer casting process, achieved by coating an HDPE film with a PVA+glue composite HD-CPE film. In some embodiments, when the packaging film includes HD-CPE, the packaging film can have the following design: HD-MDOPE/PVA//Adh//HD-CPE, wherein the HD-CPE is formed by a 3-, 5-, 7-, 9- or 11-layer casting process, achieved by coating an HD-MDOPE film with a PVA+glue composite HD-CPE film. In some embodiments, when the packaging film includes HD-CPE, the packaging film can have the following design: HD-BOPE/PVA//Adh//HD-CPE, wherein the HD-CPE is formed by a 3-, 5-, 7-, 9- or 11-layer casting process, achieved by coating an HD-BOPE film with a PVA+glue composite HD-CPE film.

In some embodiments, the packaging film can include a transparent alumina coating. In an embodiment, when the outer base film includes a transparent alumina coating, the packaging film can have the following design: AlO-HDPE//Adh//HDPE, achieved by applying an AlO-HDPE high-density blown polyethylene alumina coating and bonding with a glue composite HDPE film. In another embodiment, the packaging film can have the following design: AlO-HD-MDOPE//Adh//HDPE, achieved by applying an AlO-HD-MDOPE high-density uniaxially stretched polyethylene alumina coating and bonding with a glue composite HDPE film. In another embodiment, the packaging film can have the following design: AlO-HD-BOPE//Adh//HDPE, achieved by applying an AlO-HD-BOPE high-density biaxially stretched polyethylene alumina coating and bonding with a glue composite HDPE film. In another embodiment, the packaging film can have the following design: AlO-HD-CPE//Adh//HDPE, achieved by applying an AlO-HD-CPE high-density cast polyethylene alumina coating and bonding with a glue composite HDPE film. In another embodiment, the packaging film can have the following design: AlO-HDPE//Adh//HD-CPE, achieved by applying an AlO-HDPE high-density blown polyethylene alumina coating and bonding with a glue composite HD-CPE film. In another embodiment, the packaging film can have the following design: AlO-HD-CPE//Adh//HD-CPE, achieved by applying an AlO-HD-CPE high-density cast polyethylene alumina coating and bonding with a glue composite HD-CPE film. In another embodiment, the packaging film can have the following design: AlO-HD-MDOPE//Adh//HD-CPE, achieved by applying an AlO-HD-MDOPE high-density uniaxially stretched polyethylene alumina coating and bonding with a glue composite HD-CPE film. In another embodiment, the packaging film can have the following design: AlO-HD-BOPE//Adh//HD-CPE, achieved by applying an AlO-HD-BOPE high-density biaxially stretched polyethylene alumina coating and bonding with a glue composite HD-CPE film. In some embodiments, the HDPE described herein can be formed by a 3-, 5-, 7-, 9- or 11-layer co-extrusion blown film process. In some embodiments, the HD-CPE described herein can be formed by a 3-, 5-, 7-, 9- or 11-layer casting process.

The packaging films disclosed herein may be used for many purposes but are especially useful for high-barrier packaging applications. The packaging films may be used in a portion of a package or as the entire package. As compared to previously available recyclable packaging films, the embodiments described herein have superior properties in high barrier and recyclability. The packaging films can be used in critical high-performance packaging applications that require high barrier to help extend the shelf life of a packaged product. The embodiments described herein also provide simple recyclability, adding to the product appeal at retail points. Consumers desire packaging that has a good sustainability advantage, such as recyclability.

In some embodiments, the packaging films described herein can be used for hermetic packaging. Hermetic packaging is critical for a wide variety of products, including foods, beverages, pharmaceuticals, consumer goods and other sensitive products. Hermetic packaging can help prevent damage to the product. For many products, achieving good heat seals to create consistently hermetic packages is highly critical. An advantage of the packaging films disclosed herein is that they are more heat resistant and thus can be formed into hermetic packaging on a more reliable basis. The combination of the high heat resistance of the HDPE outer base film and the inner scaling film that provides quality seals is an important advantage to the packaging films presented herein.

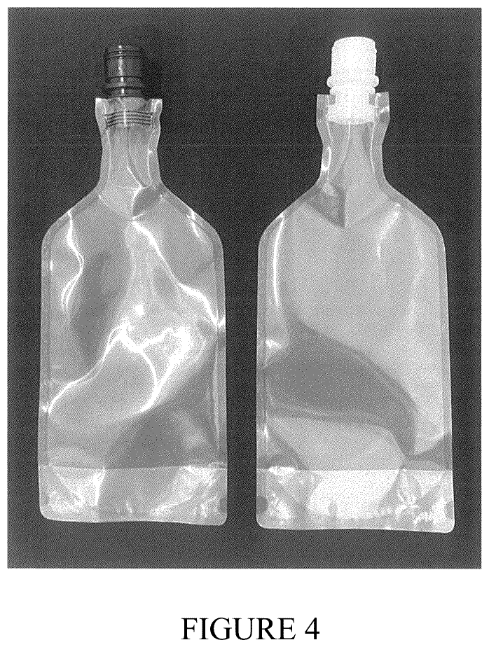

A product package made from the packaging films described herein can be suitable for containing many goods, including those sensitive to oxygen and moisture, or other applications where long shelf life is desired. Products advantageously packaged in the packaging films described herein include, but are not limited to, fresh foods, frozen foods, shelf stable foods, medications, pharmaceuticals, nutraceuticals, supplements, cosmetics, pet foods, chemicals, medical devices, shampoo, cleaners, baby wipes and any other products typically packaged in high performance packaging. FIG. 4 shows an embodiment of a product package made from the packaging films described herein, which is suitable for storing liquids. In any embodiments of the packaging film described herein, the packaging film can be used as a flexible liquid container.

One method of manufacturing a packaging film as described herein can include the following steps. One or more HDPE layers can be extruded to form an outer base film. The outer base film can optionally be oriented in the machine direction and can be optionally oriented in the transverse direction. The outer base film can be annealed. The outer base film or the inner sealing film can be coated with the barrier material. The outer base film and the inner sealing film can be connected to form the packaging film, wherein the barrier material is between the outer base film and the inner scaling film. The method of manufacturing a packaging film can include other steps, such as, but not limited to, lamination (such as dry lamination, solvent free lamination, or extrusion lamination), casting, printing indicia, heat sealing the packaging film to form a package, or irradiating the outer base film to form crosslinks in at least an outer surface of the outer base film.

It is understood by those of skill in the art that numerous and various modifications can be made without departing from the spirit of the present disclosure. Therefore, it should be clearly understood that the embodiments of the present disclosure are illustrative only and not intended to limit the scope of the present invention.

### EXAMPLES

The examples below are non-limiting and are merely representative of various aspects of the present disclosure.

As a point of reference, pure HDPE typically has a density of 0.940-0.965 g/cm³, a melting temperature of 120-140° C., a heat deflection temperature of 75-115° C., a tensile strength of 20-40 MPa, elongation at break between 500 and 1000%, hardness (Shore D) between 60 and 70, WVTR of about 0.4 to about 1.2 g/m² per 24 hours, and OTR of about 180 cm³/m² per 24 hours per atm.

Table 1 shows HDPE/PVA//Adh//HDPE pouch physical strength. Machine direction (MD) refers to the direction that a material unwinds as it is being fed into a press, tunnel, or other device. Transverse direction (TD, also called cross direction (CD)) refers to the direction that is 90-degrees to the machine direction.

TABLE 1
HDPE/PVA//Adh//HDPE Pouch Physical Strength

| Inspection item | Requirement | Result |
|---|---|---|
| Tear Strength, notched | MD > 2.0N | MD: 8.16N |
| Film strength tearing at 90- | TD > 4.0N | TD: 11.27N |
| degree angle (N) | | |
| Tensile Strength (MPa) | MD > 30 MPa | MD: 42.2 MPa |
| | TD > 50 MPa | TD: 68.22 MPa |
| Elongation at Break | MD > 100% | MD: 187.79% |
| | TD > 50% | TD: 55.1% |
| Anti-pendulum impact | >0.6 J | 1.22 J |
| strength (J) | | |

Table 2 shows HDPE/PVA//Adh//HDPE Pouch Drop testing results. Ten samples were tested per angle. Each sample was dropped at a given angle 10 consecutive times from a height of about 4 ft (1-1.2 m). “Pass” indicates that the sample did not rupture.

TABLE 2
HDPE/PVA//Adh//HDPE Pouch Drop Testing,
10 times per Pouch, 100 times per Angle

| | Trial | Trial | Trial | Trial | Trial | Trial | Trial | Trial | Trial | Trial | |
|---|---|---|---|---|---|---|---|---|---|---|---|
| Angle | 1 | 2 | 3 | 4 | 5 | 6 | 7 | 8 | 9 | 10 | Result |
| 0° | Pass | Pass | Pass | Pass | Pass | Pass | Pass | Pass | Pass | Pass | 10 pcs |
| | | | | | | | | | | | Pass |
| 45° | Pass | Pass | Pass | Pass | Pass | Pass | Pass | Pass | Pass | Pass | 10 pcs |
| | | | | | | | | | | | Pass |
| 90° | Pass | Pass | Pass | Pass | Pass | Pass | Pass | Pass | Pass | Pass | 10 pcs |
| | | | | | | | | | | | Pass |

The melting temperature of a sample of HDPE/PVA//Adh//HDPE was determined as follows. Testing conditions included a purge gas flow rate of 99.999% nitrogen at 50 mL/min. Temperature increased from 40° C. to 200° C. at a rate of 10° C./min. Analysis was performed by Differential Scanning calorimetry (DSC). Results from the sample test are summarized in Table 3.

TABLE 3

| | | Second |
|---|---|---|
| | First heating scan | heating scan |
| Melting extrapolated onset | 117.6° C. | 119.6° C. |
| temperature | | |
| Melting peak temperature | 126.7° C. and 129.2° C. | 128.4° C. |
| Melting extrapolated end | 134.9° C. | 134.0° C. |
| temperature | | |

The density of samples can be determined by liquid displacement or buoyancy methods. These methods are suitable for measuring the density of thin films and are often used in quality control and material analysis. The method is as follows: the mass of the sample is measured in air (“m_{s_air}”); the sample is fully submerged in a liquid with a known density (“d_{liquid}”) and its mass is remeasured in the liquid (“m_{s_liquid}”); density of the sample is calculated as

$$\frac{{m}_{s\_ air} \times {d}_{liquid}}{{m}_{s\_ air} - {m}_{s\_ liquid}} .$$

The density of HDPE plastic films typically ranges from 0.940 g/cm³ to 0.965 g/cm³. The density of Sample HDPE/PVA//Adh//HDPE was measured to be 0.951 g/cm³.

The oxygen transmission rate (OTR) of the packaging film was analyzed according to standard testing protocols known in the art, such as ASTM D 3985, ASTM F1927, and ISO 15105-2, and on instruments such as MOCON OX-TRAN 2/22. Testing conditions included oxygen gas at a relative humidity of 0%, a gas pressure of 760 mmHg, and a temperature of 23° C., and a carrier gas of 98% nitrogen and 2% hydrogen at a relative humidity of 0%. The oxygen transmission rate of a first sample of HDPE/PVA//Adh//HDPE was measured to be 0.22 cm³/m² per 24 hours and 0.24 cm³/m² per 24 hours. The oxygen transmission rate of a second sample of HDPE/PVA//Adh//HDPE was measured to be 0.40 cm³/m² per 24 hours.

The water vapor transmission rate (WVTR) of the packaging film was analyzed according to standard testing protocols known in the art, such as ASTM F 1249, and on instruments such as MOCON PERMATRAN-W 3/34. Testing conditions included water vapor at a relative humidity of 90%, a gas pressure of 760 mmHg, and a temperature of 38° C., and a carrier gas of nitrogen at a relative humidity of 0%. The WVTR of samples of HDPE/PVA//Adh//HDPE were measured to be 2.6645 g/m² per 24 hours, 2.7194 g/m² per 24 hours, and 2.8463 g/m² per 24 hours.

What is claimed is:

1. A packaging film, comprising:
a) an outer base film;
b) an inner sealing film; and
c) a barrier material, wherein the barrier material is between the outer base film and the inner sealing film;
wherein the outer base film comprises high-density polyethylene (HDPE),
the inner sealing film comprises HDPE and metallocene polyethylene (mPE),
the packaging film comprises at least 90% HDPE by weight,
the packaging film has an oxygen transmission rate of 1 cm³/m² per 24 hours or less, and
the packaging film is fully recyclable under SPI Code 2.

2. The packaging film of claim 1, wherein the packaging film comprises at least 95% HDPE by weight.

3. The packaging film of claim 1, wherein the oxygen transmission rate is less than 0.66 cm³/m² per 24 hours.

4. The packaging film of claim 1, wherein the oxygen transmission rate is 0.17 cm³/m² per 24 hours to 1 cm³/m² per 24 hours.

5. The packaging film of claim 1, wherein the packaging film has a water vapor transmission rate from about 0.1 g/m² per 24 hours to about 3.0 g/m² per 24 hours.

6. The packaging film of claim 5, wherein the packaging film has a water vapor transmission rate from about 1.0 g/m² per 24 hours to about 3.0 g/m² per 24 hours.

7. The packaging film of claim 1, wherein the thickness of the packaging film is from about 15 μm to about 200 μm.

8. The packaging film of claim 1, wherein the density of the packaging film is from about 0.94 g/cm³ to about 1 g/cm³.

9. The packaging film of claim 1, wherein the packaging film does not comprise polyvinyl chloride, low-density polyethylene, polypropylene, polystyrene, or polylactic acid.

10. The packaging film of claim 1, wherein the outer base film is selected from the group consisting of a linear HDPE film, a high-density machine-direction orientation polyethylene (HD-MDOPE) film, a high-density biaxially oriented polyethylene (HD-BOPE) film, a high-density cast polyethylene (HD-CPE) film, an alumina coated HDPE film, an alumina coated HD-MDOPE film, an alumina coated HD-BOPE film, and an alumina coated HD-CPE film, and combinations thereof.

11. The packaging film of claim 1, wherein the outer base film is formed by a blown film or co-extrusion process with 1, 2, 3, 5, 7, 9 or 11 layers.

12. The packaging film of claim 11, wherein one or more individual layers in the outer base film are bonded together with an adhesive.

13. The packaging film of claim 1, wherein the outer base film comprises HD-MDOPE or HD-BOPE, and wherein the outer base film has a free shrinkage rate of less than 7% in the longitudinal/machine direction and less than 7% in the transverse direction when heated to about 90° C.

14. The packaging film of claim 1, wherein the barrier material comprises a polyvinyl alcohol (PVA) or ethylene vinyl alcohol (EVOH), or a combination thereof.

15. The packaging film of claim 14, wherein the barrier material has a thickness from about 0.5 μm to about 20 μm.

16. The packaging film of claim 1, wherein the inner sealing film comprises mPE and a HDPE selected from the group consisting of a linear HDPE film, a HD-MDOPE film, a HD-BOPE film, a HD-CPE film, an alumina coated HDPE film, an alumina coated HD-MDOPE film, an alumina coated HD-BOPE film, and an alumina coated HD-CPE film, and combinations thereof.

17. The packaging film of claim 16, wherein the inner sealing film is formed by a blown film process with 1, 2, 3, 5, 7, 9 or 11 layers.

18. The packaging film of claim 1, wherein the outer base film comprises at least 2 layers of HDPE bonded together with a barrier material comprising EVOH through a co-extrusion blown film process using 2 layers of tie material.

19. The packaging film of claim 1, wherein the inner sealing film and the barrier material comprising EVOH are bonded together through a co-extrusion blown film process using 2 layers of tie material.

20. The packaging film of claim 1, wherein the packaging film is at least 80% transparent.

21. A product package comprising the packaging film of claim 1, wherein the product package is suitable for liquid storage.

22. The product package of claim 21, wherein the packaging film is flexible, and is in a form selected from a pouch, a bag, or a bag-in-box liner.

23. A method of manufacturing the packaging film of claim 1, comprising:
a) extruding one or more high-density polyethylene film layers to form the outer base film;
b) orienting the outer base film in the machine direction;
c) annealing the outer base film;
d) coating the barrier material onto the outer base film or the inner sealing film; and
e) connecting the outer base film to the inner sealing film to form the packaging film, wherein the barrier material is between the outer base film and the inner sealing film.

24. A method of manufacturing a product package, comprising the method of manufacturing the packaging film according to claim 23, and further comprising heat sealing the packaging film to form a product package.

25. The method of manufacturing the product package according to claim 24, further comprising irradiating the outer base film to form crosslinks in at least an outer surface of the outer base film.
